(19) United States
(12) Patent Application Publication
(10) Pub. No.: US 2026/0281963 A1
(43) Pub. Date: Sep. 17, 2026

(54) AUTOMATICALLY SELECTING ANCHOR ACCESS POINTS

(71) Applicant: Hewlett Packard Enterprise Development LP, Spring, TX (US)

(72) Inventors: Vikram Raghu, Santa Clara, CA (US); Denis Houle, Ste-Anne-De-Bellevue (CA); Mathieu Mercier, Laval (CA)

(21) Appl. No.: 19/079,177

(22) Filed: Mar. 13, 2025

(51) Int. Cl. H04W 64/00; H04W 16/18

(52) U.S. Cl. CPC H04W 64/003; H04W 16/18

(57) ABSTRACT

In certain implementations, techniques for selecting anchor access points include accessing a relative position map of access points (APs) of a wireless network, the relative position map determined according to distance measurements between pairs of APs and corresponding to a first coordinate system. The techniques include determining subset of the APs located at an outer boundary of the relative position map. The techniques include calculating areas for different combinations of the subset of APs, each combination including a target quantity of APs, and selecting, based on the areas, a set of anchor APs for determining physical locations of the APs. The physical locations correspond to a second coordinate system, the first coordinate system being independent of the physical locations of the APs, the set of anchor APs having the target quantity of APs.

### BACKGROUND

A communication network includes various electronic devices that are able to communicate with one another via one or more communication interfaces. For example, a wireless local area network (WLAN) is a wireless computer network that links two or more electronic devices using a wireless distribution technique (e.g., radio or infrared signals). A WLAN typically is implemented within a limited area, referred to as a facility, such as a home, college, school, or an office complex. A communication network, some or all of which may be a wireless network, may include numerous access points (APs), such as wireless access points (WAPs). The access points may be network devices to which client devices connected wirelessly to access a communication network. As just one example, numerous access points may be deployed at various physical locations throughout a facility to provide coverage over an extended area.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example system for automatically selecting anchor access points, according to certain implementations;

FIG. 2 illustrates an example auto-locate computer system, according to certain implementations;

FIG. 3 illustrates an example method for automatically selecting anchor access points, according to certain implementations;

FIGS. 4A-4D illustrate example visualizations to facilitate describing the method of FIG. 3, according to certain implementations;

FIGS. 5A-5B illustrate examples of relative position map, according to certain implementations;

FIG. 6 illustrates example AP location data structure, according to certain implementations;

FIG. 7 illustrates an example method for automatically selecting anchor access points, according to certain implementations;

FIG. 8 illustrates an example scenario in which less than a target quantity of access points is determined to be at an outer boundary of relative position map, according to certain implementations; and

FIG. 9 illustrates an example method for automatically selecting anchor access points, according to certain implementations.

### DESCRIPTION

Accurate knowledge of the physical locations of the APs of a managed communication network may be useful for various purposes, such as network planning, optimizing coverage, troubleshooting, providing location-based services, and/or other network management or other tasks. Once APs are installed at a facility, determining the physical locations of the APs within the facility can be challenging. For example, employing a human user to accurately identify the physical locations of APs in a facility and record those locations on a floor map during or after installation can be a time-consuming, labor-intensive, and/or error-prone task. Furthermore, changes to the set of APs may occur over time. For example, an AP may be moved from one location to another location, new APs may be added, and/or one or more APs may be removed. Updating the locations of the APs to reflect these or other changes may take additional time and resources; yet, failing to accurately update the locations may be problematic.

It may be possible to automatically calculate the locations of the APs of a managed network (e.g., associated with a facility), a solution that may be referred to as an automatic location (or auto-locate) feature, and that allows a user to determine, record, and/or view the positions of APs on a geo-referenced floor plan (e.g., provided by the user) through the user interface. When the auto-locate feature is initiated, the APs in a given area may perform Fine Timing Measurement (FTM) (or another suitable type of) scans to measure distances between each AP and the other APs. In certain implementations, the FTM scans can be performed either as a background task or as a dedicated scan. If the FTM scans are performed as a background task, the FTM scans can be taken continuously without disrupting normal network operations. A dedicated scan can be initiated for more immediate or focused measurements. The auto-locate feature may collect the results of the FTM scans and generate a relative distance data structure (e.g., a proximity matrix) of inter-access-point distances (e.g., the distances between each AP and the other APs). The auto-locate feature may use the relative distance data structure as an input to compute the positions of the APs on the geo-referenced floor plan.

In addition to the relative distance proximity matrix, the positions of a set of anchor access points may be manually input on the geo-referenced floor plan by a user using an input device (e.g., a keyboard input or a mouse input). These anchor APs are placed on the floor plan by the user as accurately as possible. The positions of the anchor access points serve as reference positions, and the combination of the proximity matrix and the positions of the anchor access points are used as inputs for the algorithm to generate a map of AP positions throughout the floor plan.

Continuing with the auto-locate feature, in a first step, an auto-locate module may use a Multi-Dimensional Scaling (MDS) algorithm to generate an initial set of AP positions based on the generated relative distance data structure (e.g., proximity matrix). The relative distance data structure may include the distances between all pairs of APs. The auto-locate module may transform these distances into a set of points in a first (e.g., Cartesian) coordinate system, representing the relative positions of the APs, including the anchor APs. At this stage, the positions of the APs are in an arbitrary coordinate system, and not yet aligned with the actual floor plan. In a second step, the auto-locate module may compute transformations to align the initial set of AP positions with the geo-referenced floor plan. This may be generated using the user-provided positions for the anchor access points, including computing a transformation that maps the initial set of AP positions to the floor plan coordinates. In a third step, the computed transformation may be applied to the initial set of AP positions to obtain a corresponding final set of AP positions according to the transformation.

As described above, manual input of certain AP locations (e.g., locations of the anchor access points) may be used to properly orient and place the set of APs within a facility's coordinate system. The selection of which APs to use as anchor access points can potentially significantly impact the accuracy of the final positioning results, but customers may not know which APs would serve as optimal anchor access points or, if given only vague guidance, may poorly select the anchor access points. Certain implementations of this disclosure attempt to automatically select an optimal set of three or more APs to serve as the anchor access points. In certain implementations, an optimal set of anchor access points includes four anchor APs.

In certain implementations, a technique for automatically selecting anchor access points for determining locations of a set of APs may be referred to as an anchor access point selection algorithm and may include a two step process. The two step process may be performed using the relative distance data structure (e.g., the proximity matrix) and the initial set of coordinates for the APs. These APs may have a shape according to the initial set of coordinates. The shape may be positioned within the arbitrary coordinate space within which the initial set of coordinates exist.

In a first step of the two-step process, an anchor access point selection module may identify APs that are edge access points of the shape formed according to the initial set of coordinates. In certain implementations, this edge determination may be performed using a convex hull algorithm. This first step provides a subset of the APs of the managed network.

In a second step of the two-step process, areas of polygons formed by different combinations of APs of the subset of APs are determined to identify the combination with the maximum area. The combination with the maximum area is determined to be the set of anchor access points. The number of APs from the subset included in each combination is determined according to the quantity of APs preferred for the set of anchor access points. In certain implementations, the quantity is at least three. In some implementations, the quantity is three (meaning the areas being calculated are for triangles) or four (meaning the areas calculated are for quadrilaterals), with four showing better performance (less error in the final location determinations) according to certain tests. In general, a goal of the second step is to identify the n (n being the quantity of APs desired for the anchor access points) APs of the subset of APs that are as far apart as possible.

The result of these steps is a set of APs—referred to as anchor access points—that can be used to link the initial locations for the APs, as determined according to the relative distance data structure, to the physical locations of the facility, as may be represented in a floor plan or other map having its own coordinate system. A user could input the physical locations of the automatically selected APs, and then the auto-locate algorithm could perform the transformation for all the APs in the managed network based on the physical locations of the selected anchor access points.

In certain implementations, it may be possible to omit the first step and simply apply the second step to the entire set of APs. Processing costs associated with this technique may increase as a quantity of APs increases. For example, this may be computationally inexpensive for a facility that includes a relatively smaller number of APs. As another example, this may be computationally expensive at a facility that includes hundreds or thousands of APs.

In certain implementations, at least two outlier scenarios may occur that can be handled using various techniques to still automatically select suitable anchor access points. Each of these examples of outlier scenarios and associated handling is described briefly below.

In a first example outlier, in a scenario in which the target quantity of APs (which may reflect a target quantity of APs) is n, it is possible that the first step of the anchor access selection point process results in less than n (e.g., n−1) APs. In such an example, it may be possible to proceed with only n−1, and changing the target quantity of APs to n−1. Alternatively, the anchor point selection algorithm may discard one of the n−1 APs, and re-run the convex hull algorithm (or other suitable edge detection algorithm) to attempt to identify at least n APs for the subset of APs of the first step.

In a second example outlier, in a scenario in one of the automatically selected anchor access points is hard to locate at the physical site, the algorithm can discard that hard-to-locate AP and offer alternate AP using the remaining n−1 access points to find the next best possible candidate. This could occur, for example, where one of the automatically selected APs is in a difficult to reach location.

In certain implementations, a solution for managing and locating APs (including automatically selecting anchor access points) may be implemented as a network application (e.g., cloud-based application), such as, for example, an enterprise application. The solution may operate on a system that includes several interconnected components, such as, for example, a cloud-based server infrastructure and a user interface (e.g., a web-based user interface) for network administrators and/or other users. The solution may provide the automatic location feature that allows a user to determine and record the positions of APs on a geo-referenced floor plan (e.g., provided by the user) through the user interface, including, for example, indicating to the user which APs are to be anchor access points and allow the user to input the respective physical locations of those anchor access points.

Certain implementations of this disclosure may provide one or more of the following technical advantages. This automated selection process may minimize positioning errors and reduce or eliminate instances of customers (or other users) making potentially suboptimal manual selections of reference points (anchor access points). In certain implementations, the automatic anchor access point selection algorithm may increase the chances that an optimum set of anchor access points is used to perform an auto-locate operation. This may reduce or eliminate errors in the locations of APs determined by the auto-locate operation, potentially improving the overall accuracy of the auto-locate feature. Having a more accurate identification of the locations of the APs of the facility may facilitate improvement of the operation of the network and/or ease management of the network (which also may lead to improved operation of the network). For example, certain implementations may allow a user (e.g., a network administrator) to accurately determine and record the positions of APs on a user uploaded geo-referenced floor plan without the user having to manually indicate the physical position of every AP device on the floor plan. By using the automatic location feature, only the positions of a few anchor access points (e.g., four anchor access points) may be indicated by the user, which may reduce the amount of time and effort to accurately map AP locations, especially in large-scale wireless network deployments. The optimum anchor access point selection positioning facilitated by this solution may allow for optimized network coverage, more efficient troubleshooting, and enhanced location-based services, including improved indoor navigation, asset tracking, and emergency response capabilities. Further, the reduction in user input errors and on-site verifications may result in lower operational costs for both service providers and enterprise clients.

In certain implementations, automatically identifying APs to use as the anchor access points may reduce a burden on a human to identify appropriate APs for the anchor access points. In certain implementations, automatically identifying APs to use as the anchor access points may reduce errors associated with relying on a human to identify appropriate APs for the anchor access points.

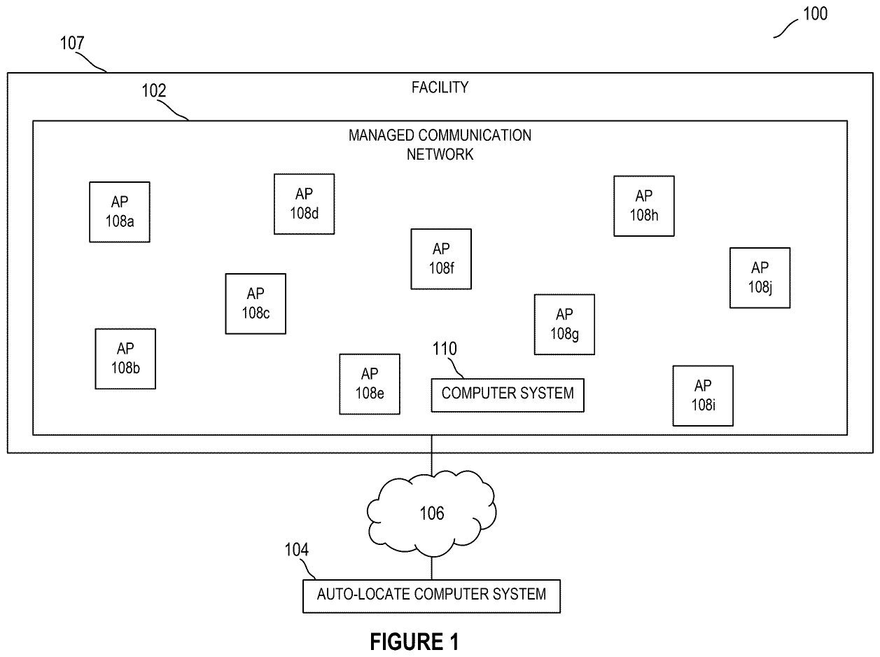

Turning to the figures, FIG. 1 illustrates an example system 100 for automatically selecting anchor access points, according to certain implementations. In the illustrated example, system 100 includes a managed communication network 102, an auto-locate computer system 104, and communication network 106. Although a particular implementation of system 100 is illustrated and described, this disclosure contemplates any suitable implementation of system 100.

In general, auto-locate computer system 104 may be configured to implement an auto-locate feature to automatically determine physical locations of APs (e.g., WAPs) of managed communication network 102. Auto-locate computer system 104 may be configured to determine automatically which APs of managed communication network 102 to use as anchor access points, whose physical locations are to be provided, to serve as reference points for determining the physical locations of the other APs of managed communication network 102.

Managed communication network 102 may include controllers, APs, switches, routers, or the like for providing network connectivity to client devices. Managed communication network 102 may be implemented at one facility 107 or may span multiple facilities 107, and may be located at one general geographic location or may span multiple geographic locations.

Managed communication network 102 may include one or more APs 108a-108j, which may be referenced generally as AP 108/APs 108. Managed communication network 102 may represent actual APs 108 that are deployed in a facility 107. Although FIG. 1 shows managed communication network 102 to include a particular number of APs 108, managed communication network 102 may include any suitable number of APs 108. APs 108 may provide a point of access to a communication network, such as managed communication network 102 and/or a network external to managed communication network 102 (e.g., communication network 106). APs 108 may control or otherwise facilitate network access of client devices and, in certain implementations, may authenticate client devices for connecting to APs 108 and through APs 108, potentially to other devices within managed communication network 102 or outside of managed communication network 102. An AP 108 may be implemented using any suitable combination of hardware, firmware, and software that is configured to provide wireless network connectivity to wireless client devices. APs 108 may communicate with the network over connections, which may be wired or wireless interfaces.

APs 108 may each include a device, such as a wireless router, that allows wireless devices to connect to the WLAN implemented by some or all of managed communication network 102 and/or a network external to managed communication network 102. APs 108 may each act as radio transmitters for a WLAN. APs 108 may each translate network traffic into radio signals and transmit those signals to wireless enabled processing devices. For example, APs 108 may each act as a bridge to a wired local area network (LAN). For example, an AP 108 may be connected to a wired network via WLAN controller, which in turn may be coupled to a cable in order to allow wirelessly-enabled client devices access to a wired network. An AP 108 may include, but is not limited to, a Wi-Fi AP operating under operating under one or more IEEE (Institute of Electrical and Electronics Engineers) 802.11 standards. An AP 108 may also operate using any other wireless communication technology, including, for example, cellular communications (including 4G, 5G, or 6G technology or beyond), BLUETOOTH, ZIGBEE, and other technologies.

APs 108 may be dispersed throughout a physical environment (e.g., throughout a facility or campus) to provide connectivity to client devices, potentially as those client devices move throughout the physical environment. This disclosure contemplates the physical environment in which APs are dispersed being one or multiple geographic locations, potentially spanning a large area and potentially including multiple geographic regions that are physically remote from each other (e.g., different buildings and/or sites). APs 108 may be spaced apart in two or more dimensions. For example, managed communication network 102 may be a business facility, and APs 108 may be dispersed throughout the business facility to provide client devices with network access to other devices of managed communication network and/or to other communication networks (e.g., to the Internet).

Client devices may represent any type of computing device capable of reading machine-executable instructions and network connectivity. Examples of the computing device may include a server, a desktop computer, a notebook computer, a tablet computer, a thin client, a mobile device, a personal digital assistant (PDA), a smart phone, a printer, and Internet-of-Things device, or any other suitable type of computing device. In certain implementations, a client device includes a wireless network interface (e.g., a wireless network interface card (NIC)) that allows client device to perform wireless communication with another device, such as one or more APs 108.

One or more structures may be located in the physical environment in which managed communication network 102 is implemented. Those structures may include walls, floors, furniture, windows, or other potential obstacles that may interfere with or otherwise obstruct an ability of client devices to connect to a particular AP 108. Furthermore, an AP 108 may have a limited range in which client devices may connect to the AP 108. In some implementations, APs 108 may be positioned throughout a physical environment in a manner that promotes availability of an AP 108 to a client device regardless of where the client device is in the physical environment. In certain implementations, APs 108 may be positioned throughout the physical environment in a manner that provides whole or partial overlap of coverage areas of the APs 108, potentially providing redundant available connections in certain areas. This approach may increase the opportunity for a client device to find an available AP 108 for connection even if one or more APs 108 is temporarily or permanently out of service, such as may be the case when an AP 108 experiences a technical problem, reboots, or is otherwise unavailable.

In certain implementations, managed communication network 102 may include a computer system 110, which may be configured and/or usable to control certain operations of APs 108. For example, computer system 110 may provide an interface and/or other capabilities via which a user can input information about managed communication network 102, such as information indicating the physical locations of one or more of APs 108 (e.g., those selected as anchor access points). As another example, computer system 110 may be able to display a visual representation of a floor plan of a facility in which managed communication network 102 is installed, and to indicate on the floor plan the physical locations of APs 108. In certain implementations, computer system 110 is able to access those features via auto-locate computer system 104, such as by accessing those features through a web interface.

Although FIG. 1 shows computer system 110 to be part of managed communication network 102, computer system 110 may be external to managed communication network 102, if appropriate. Computer system 110 may be any suitable type of processing device, such as a desktop, server, laptop, smartphone, for example. In certain implementations, computer system 110 may be a computing device through which a user associated with managed communication network 102 can input information about managed communication network 102 and provide that information to auto-locate computer system 104.

APs 108 may be configured to provide certain network information to one or more other devices of system 100. For example, APs 108 may provide network information to auto-locate computer system 104, directly or potentially indirectly through one or more other devices that are configured to provide the network information to auto-locate computer system 104. The contents of the network information are described in greater detail below but may include information useful to auto-locate computer system 104 for automatically selecting a subset of APs 108 to be anchor access points for determining physical locations of APs 108 of managed communication network 102. Some or all of this network information may be provided to another system associated with auto-locate computer system 104 for one or more purposes in addition to managing a software update of APs 108. For example, auto-locate computer system 104 may be, or may be part of, a network management system (NMS), and the NMS may collect the network information for a variety of purposes associated with managing managed communication network 102.

Auto-locate computer system 104 may be, or may be part of, a central point of control that is accessible by the administrators of managed communication network 102. In certain implementations, auto-locate computer system 104 could be, or could be part of, an NMS. Auto-locate computer system 104 may be, or may be part of, a computer system that includes any suitable components. Suitable components may include one or more processors, one or more application-specific integrated circuits (ASICs), a microcontroller, memory, and/or other suitable components. Auto-locate computer system 104 may be a physical device (e.g., an NMS computer). Auto-locate computer system 104 may receive commands from a user interface and display output with the user interface. The user interface may be a command line interface, a graphical user interface, a web interface, or another suitable type of interface. Auto-locate computer system 104 may process the commands from the user interface, validate the commands, and execute logic specified by the commands. Auto-locate computer system 104 may output the results of commands via the user interface. An administrator may access auto-locate computer system 104 using the user interface. The user interface may be a central point of access for auto-locate computer system 104.

Auto-locate computer system 104 may perform a variety of operations such as executing various algorithms for automatically selecting anchor access points from APs 108, determining physical locations of APs 108, processing data from managed communication network 102, and managing interactions with a user interface (described below). Auto-locate computer system 104 also may process user inputs, such as for example, floor plan data and generate outputs, such as for example, indications of anchor access points and determined physical locations of APs 108 (e.g., within a floor plan) for visualization.

Auto-locate computer system 104 may be configured to implement an auto-locate feature to automatically determine physical locations of APs 108 of managed communication network 102. Auto-locate computer system 104 may be configured to determine automatically which APs 108 of managed communication network 102 to use as anchor access points, whose physical locations are to be provided, to serve as reference points for determining the physical locations of the other APs 108 of managed communication network 102. The solution may be implemented as a cloud-based application, such as for example, an enterprise application. Auto-locate computer system 104 may be, for example, a cloud-based server, a dedicated hardware appliance, or a virtualized environment within an enterprise data center.

In general, auto-locate computer system 104 is configured to implement an auto-locate feature that can automatically determine the locations of APs 108 within the facility in which managed communication network 102 is implemented. APs 108 may be physically dispersed throughout the facility, potentially in two or three dimensions, and the physical layout of the facility may be represented as a floor plan, which itself may potentially be a two- or three-dimensional representation of the facility that is scaled for visual display by a computing device (e.g., auto-locate computer system 104 and/or computer system 110). That floor plan may be associated with a coordinate system that can represent locations in two and/or three dimensions. The auto-locate feature may attempt to determine the physical locations of APs 108, and potentially to represent those physical locations in a visualization of the floor plan.

As part of automatically determining the locations of APs 108, the auto-locate feature may benefit from knowing in advance the physical locations of a target quantity of APs, which may reflect a target quantity of anchor APs. That is, a target quantity of APs 108 may serve as anchor APs 108 whose known locations provide reference points for determining the physical locations of other APs 108. In certain implementations, the target quantity of APs is three or more anchor access points. In a particular example, the target quantity of APs is four anchor access points.

Certain implementations provide an automated anchor access point selection feature that automatically selects a subset (of the target quantity) of the APs 108 to be the anchor access points for the auto-locate feature. The automated anchor access point selection feature may be provided as part of the auto-locate feature. In general, the anchor access point selection technique attempts to identify automatically APs 108 in managed communication network 102 that are furthest apart from one another. This may increase the accuracy of the locations identified for the other APs 108 of managed communication network 102, such as may be determined by the auto-locate feature.

Auto-locate computer system 104 can then indicate the selected set of anchor access points, such as to a user who can input the physical locations of the APs 108 that have been selected as the anchor access points. Auto-locate computer system 104 can then use the physical locations of the anchor access points to determine the physical locations of the other APs 108 of managed communication network 102.

Auto-locate computer system 104 may communicate with components of managed communication network 102 via communication network 106. Communication network 106 may facilitate wireless and/or or wired communication. Communication network 106 may communicate, for example, IP packets, Frame Relay frames, ATM cells, voice, video, data, and other suitable information between network addresses. Communication network 106 may include any suitable combination of one or more local area networks (LANs), radio access networks (RANs), metropolitan area networks (MANs), wide area networks (WANs), mobile networks (e.g., using WiMax (802.16), WiFi (802.11), 3G, 4G, 5G, or any other suitable wireless technologies in any suitable combination), all or a portion of the global computer network known as the Internet, and/or any other communication system or systems at one or more locations, any of which may be any suitable combination of wireless and wired. Communication network 106 may include controllers, APs, switches, routers, or the like for forwarding traffic between auto-locate computer system 104 and managed communication network 102. In certain implementations, at least a portion of communication network 106 may be an Ethernet network.

Auto-locate computer system 104 may receive network information from components of managed communication network 102. For example, the network information may be received from APs 108 and/or other components of managed communication network 102 (e.g., from one or more controllers, routers, switches, computer system 110, or other components). The network information may include proximity information (e.g., distance measurements) obtained by APs 108, indications of physical locations of APs 108 in a floor plan associated with a facility in which managed communication network 102 is installed, and/or any other suitable information.

While FIG. 1 illustrates a particular configuration of components, this disclosure contemplates other suitable configurations. For example, although FIG. 1 shows certain components as being part of the same device, any of the components may be grouped in sets of one or more components which may exist and execute as part of any number of separate and operatively connected devices. As another example, a single component may be configured to perform all or any portion of the functionality performed by the components shown in FIG. 1. Accordingly, implementations disclosed herein should not be limited to the configuration of components shown in FIG. 1.

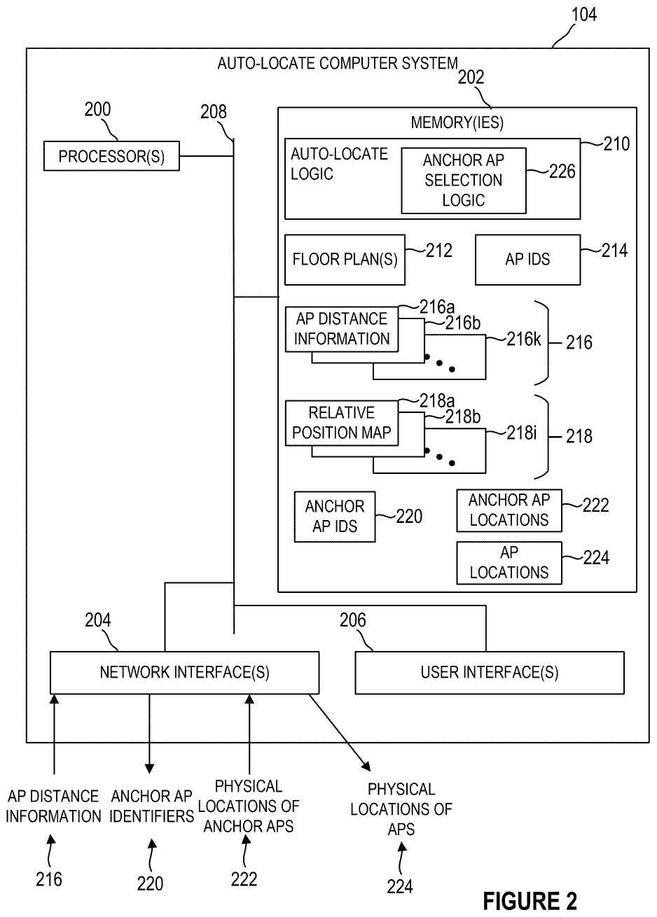

FIG. 2 illustrates an example auto-locate computer system 104, according to certain implementations. In the illustrated example, auto-locate computer system 104 includes one or more processors 200, one or more memories 202, one or more network interfaces 204, and one or more user interfaces 206, some or all of which may communicate using links 208, and all of which may be referred to in the singular for simplicity. The components of auto-locate computer system 104 may be implemented in any suitable combination of hardware, firmware, and software. Portions of auto-locate computer system 104 may described in connection with features of system 100 shown in FIG. 1.

Processor 200 may be any component or collection of components adapted to perform computations and/or other processing-related tasks. Processor 200 can be, for example, a microprocessor, a microcontroller, a control circuit, a digital signal processor, a field-programmable gate array (FPGA), an ASIC, a system-on-chip (SoC), or combinations thereof. Processor 200 may include one or more processing cores. Processor 200 may include any suitable number of processors, or multiple processors may collectively form a single processor 200.

Memory 202 may include any suitable combination of volatile memory, non-volatile memory, and/or virtualizations thereof. For example, memory 202 may include any suitable combination of magnetic media, optical media, random access memory (RAM), read-only memory (ROM), removable media, and/or any other suitable memory device. Memory 202 may include data structures used to organize and store all or a portion of the stored data. Memory 202 may include a non-transitory computer-readable medium that stores programming for execution by one or more of the one or more processor 200. One or more modules of auto-locate computer system 104 may be partially or wholly embodied as software and/or hardware for performing any functionality described herein. For example, one or more modules of auto-locate computer system 104 may be embodied as software.

Network interfaces 204 represent any suitable computer element that can receive information from a communication network (e.g., communication network 106 of FIG. 1) and transmit information through a communication network (e.g., communication network 106 of FIG. 1), or both. Network interfaces 204 represent any port or connection, real or virtual, including any suitable combination of hardware, firmware, and software, including protocol conversion and data processing capabilities, to communicate through a LAN, WAN, or other communication system that allows information to be exchanged. Network interfaces 204 may facilitate wireless and/or wired communication. Network interfaces 204 may facilitate communication between the auto-locate computer system 104 and managed communication network 102 (e.g., of FIG. 1), allowing the transmission of AP distance information 216 from APs 108 of managed communication network 102 and the delivery of configuration updates or commands to the APs 108 of managed communication network 102.

Users may interact with auto-locate computer system 104 through a user interface 206. User interface 206 may be implemented, for example, as a web-based user interface that allows access from various devices and locations. User interface 206 may be able to incorporate various visual elements such as floor plan visualizations, AP location markers, input fields for anchor access point placement, and/or other suitable features.

Links 208 may include any suitable wired or wireless communication medium for the components of auto-locate computer system 104 to communicate with one another. For example, links 208 may include any suitable combination of a bus or communication network.

Returning to memory 202, in the illustrated example, memory 202 stores auto-locate logic 210, floor plans 212, AP identifiers (IDs) 214, AP distance information 216, one or more relative position maps 218, anchor AP IDs 220, anchor AP locations 222, and AP locations 224. Each of these is described in greater detail below.

Auto-locate logic 210 may include instructions for executing an automatic location (auto-locate) feature. The auto-locate feature may allow for the automated determination of physical locations of APs (e.g., APs 108) within an environment (e.g., a facility 107 at which the APs 108 implementing managed communication network 102 are installed). Auto-locate module 210 may be implemented as a software component (e.g., running on the processor 200) that manages the collection of AP distance information 216 (described below) from managed communication network 102 and processes this data to determine physical locations of APs 108. Auto-locate logic 210 may interact with other components of system 100 of FIG. 1 to gather data and execute auto-location algorithms.

Auto-locate logic 210 may include anchor AP selection logic 226. Although illustrated as being part of auto-locate logic 210, anchor AP selection logic 226 could be separate from auto-locate logic 210. Anchor AP selection logic 226 may include instructions for executing an automatic selection of a set of APs from APs 108 to serve as anchor access points, as described in greater detail below.

Floor plans 212 represent digital copies of floor plans that correspond to facilities (e.g., facility 107) at which managed communication networks (e.g., managed communication network 102) are installed. Of course, memory 202 may store floor plans 212 for multiple different entities where managed communication networks (e.g., managed communication network 102) are installed. A user may use a visual representation of floor plans 212 to indicate the physical locations of the selected anchor APs within the facility represented by a floor plan 212, view determined locations of APs 108, and for other suitable operations. Anchor AP selection logic 226 may use a visual representation of floor plans 212 to receive physical locations of the APs 108 selected to be anchor access points and for other suitable purposes. Auto-locate logic 210 may use a visual representation of floor plans 212 to indicate determined locations of APs 108 and for other suitable purposes.

AP IDs 214 represent the identifiers of APs 108 of managed communication network 102 and located at the facility at which managed communication network 102 is installed. APs 108 may report their AP IDs to auto-locate logic 210 (or a tool associated with auto-locate logic 210, such as an NMS), or another tool at managed communication network 102 (e.g., a wireless controller, a wireless switch, computer system 110) may collect information from AP IDs 214, and possibly other information, from APs 108 and report some or all of the collected information to auto-locate logic 210 (or a tool associated with auto-locate logic 210, such as an NMS). AP IDs 214 may take any suitable form, and potentially multiple forms. For example, an AP ID 214 may be reported in a first format (e.g., a Service Set Identifier (SSID) and/or Basic Service Set Identifier (BSSID)) by an AP 108, and auto-locate computer system 104 may assign another name (e.g., “AP4”) that maps to that AP ID 214.

AP distance information 216 may include information indicating distances between actual APs 108 of managed communication network 102 located at facility 107. AP distance information 216 may include distance measurements between pairs of APs 108, potentially captured by APs 108 themselves. APs 108 may, for example, determine the distances using AP signaling, such as using measurement of time of flight of signals between pairs of APs 108 to determine the distance between each pair of APs 108. For example, a distance determination may be made between an AP 108 and each other AP 108, and between every other pair of APs 108, to the extent possible.

Memory 202 may store multiple instances of AP distance information 216, shown as AP distance information 216a, AP distance information 216b, through AP distance information 216k. Different instances of AP distance information 216 could correspond to different points in time for a same managed communication network 102, as the APs 108 of a managed communication network 102 may be moved or removed and/or one or more APs 108 may be added. Additionally or alternatively, different instances of AP distance information 216 could correspond to different managed communication networks 102. AP distance information 216 may have any suitable units or combinations of units.

As illustrated in FIG. 2, auto-locate computer system 104 may receive AP distance information 216, such as from APs 108 of managed communication network 102 of FIG. 1 and/or from one or more other elements that may aggregate network information from APs 108 of FIG. 1. For example, one or more network controllers and/or network switches of managed communication network 102 may aggregate information received from some or all of APs 108 and may report that information or derivatives of that information, including potentially AP IDs 214 and AP distance information 216, to auto-locate computer system 104. In certain implementations, portions of this network information may be received from computer system 110 of managed communication network 102 of FIG. 1, if appropriate.

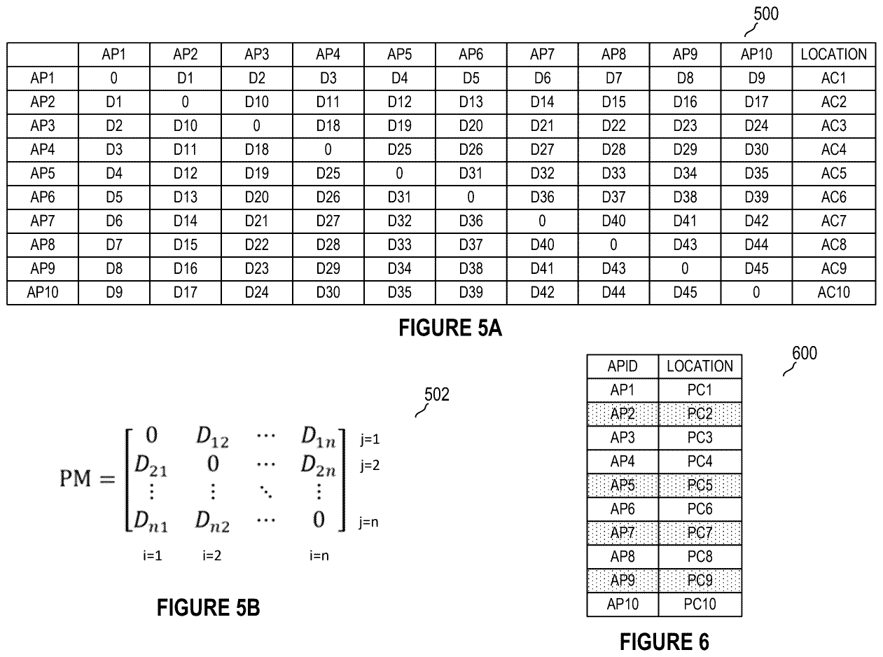

A relative position map 218 may be, or may include, a data structure (e.g., a table, a proximity matrix, or another suitable type of data structure) with entries that include distances between each pair of APs 108 of managed communication network 102. In certain implementations, relative position map 218 may include location information for APs 108, such as coordinates relative to an arbitrary coordinate system that might or might not correspond to the coordinate system of a floor plan 212 of the facility 107 at which managed communication network 102 is implemented. Although described primarily as a map, relative position map 218 may refer to a data structure containing data that could be used to generate a visual representation of a map showing the relative positions of APs 108 with respect to an arbitrary coordinate system and/or to the visual representation of the map itself. Each relative position map 218 may correspond to an instance of AP distance information 216. Additional details regarding example of at least a portion of a relative position map 218 are illustrated and described below with reference to FIGS. 5A-5B.

Memory 202 may store multiple relative position maps 218, shown as relative position map 218a, relative position map 218b, through relative position map 218i. The value of “i” might or might not equal the value of “k.” Different relative position maps 218 could correspond to different instances of AP distance information 216. The value of “i” might or might not equal the value of “k.”

Anchor AP IDs 220 may include identifiers of the APs 108 selected by anchor AP selection logic 226 from APs 108 to be the anchor access points for managed communication network 102. Anchor AP IDs 220 may have any suitable format, but in certain implementations, may correspond to AP IDs 214.

Anchor AP locations 222 may represent the physical locations of the anchor access points selected by anchor AP selection logic 226 and identified using anchor AP IDs 220. In certain implementations, in response to anchor AP selection logic 226 indicating the selected anchor access points (e.g., using anchor AP IDs 220), a user may indicate the physical location of the selected anchor APs via user interface 206. For example, a user may indicate the physical location of the selected anchor APs within the facility of managed communication network 102, such as by dragging and dropping an icon for the anchor access point indicated by a particular anchor AP ID 220 to a location on a visual representation of the appropriate floor plan 212 that corresponds to the physical location of the anchor access point in the facility (e.g., facility 107).

AP locations 224 may indicate the physical locations of APs 108 within the facility 107 associated with managed communication network 102. For example, AP locations 224 may be the locations of APs 108 determined by auto-locate logic 210 using anchor AP locations 222. AP locations 224 may include a data structure that provides a mapping of APs 108 (e.g., using AP IDs 214) to corresponding physical locations within the facility 107 associated with managed communication network 102.

Returning to auto-locate logic 210 and anchor AP selection logic 226, auto-locate logic 210 and/or anchor AP selection logic 226 may include instructions to obtain AP distance information 216 between actual APs 108 of managed communication network 102 located at facility 107. Auto-locate logic 210 and/or anchor AP selection logic 226 may include instructions to generate a relative position map 218 based on the obtained AP distance information 216.

Auto-locate logic 210 and/or anchor AP selection logic 226 may include instructions to access relative position map 218 and determine, from APs 108 (which may be considered a first plurality of APs 108), a subset of APs 108 (which may be considered a second plurality of APs 108 that is a subset of the first plurality of APs 108) located at an outer boundary of relative position map 218. In other words, auto-locate computer system 104 may process relative position map 218 to identify a subset of APs 108 located at an outer boundary of relative position map 218. Auto-locate logic 210 and/or anchor AP selection logic 226 may include instructions to calculate areas for different combinations of APs 108 of the determined subset of APs 108, each combination of the different combinations of APs 108 including the target quantity of APs 108. Auto-locate logic 210 and/or anchor AP selection logic 226 may include instructions to select, based on the calculated areas, a set of anchor access points for determining physical locations of the APs 108. In certain implementations, auto-locate computer system 104 (e.g., anchor AP selection logic 226) selects the combination of APs 108 having the maximum calculated area among the different combinations as the set of anchor access points.

Auto-locate logic 210 and/or anchor AP selection logic 226 may include instructions to obtain physical locations of the APs 108 selected to be anchor access points. The physical locations may correspond to a coordinate system that differs from the coordinate system of relative position map 218, and may correspond to a coordinate system associated with a floor plan 212 for the facility 107, potentially being geo-referenced to the physical structure of facility 107. Auto-locate logic 210 and/or anchor AP selection logic 226 may include instructions to determine physical locations of remaining APs 108 based on relative position map 218 and the obtained physical location information for the set of anchor access points. Auto-locate logic 210 and/or anchor AP selection logic 226 may include instructions to display, on a visualization of a geo-referenced floor plan 212, physical locations of APs 108 at facility 107.

Auto-locate logic 210 and/or anchor AP selection logic 226 may include instructions to perform the auto-locate feature and automatic anchor AP selection technique in accordance with techniques described throughout this disclosure. Further details of these process are described with respect to the remaining figures.

In certain implementations, anchor AP selection logic 226 accounts for situations where physical verification of the location of an AP 108 selected by anchor access point selection logic 226 to be an anchor access point is difficult or otherwise not possible. For example, an AP 108 may be temporarily inaccessible due to construction work, being located in a restricted area, being mounted in a hard-to-reach location, or otherwise being difficult to physically locate within the facility. In such a scenario, when prompted to indicate the physical location of an AP 108 selected to be an anchor access point, a user may indicate that the location is unavailable or otherwise unable to be provided.

Continuing with this example, when auto-locate computer system 104 receives an indication that the location of an AP 108 selected to be an anchor access point cannot be physically verified, anchor AP selection logic 226 may identify an alternative AP 108 to be an anchor access point, such as from the previously calculated combinations. In certain implementations, anchor AP selection logic 226 may select the alternative anchor access point from a combination having the next-largest calculated area among the different combinations. This dynamic selection process may allow the system to proceed with location determination even when optimal anchor access points are unavailable, while still maintaining accuracy by selecting alternatives that maximize the geometric distribution of the anchor access points.

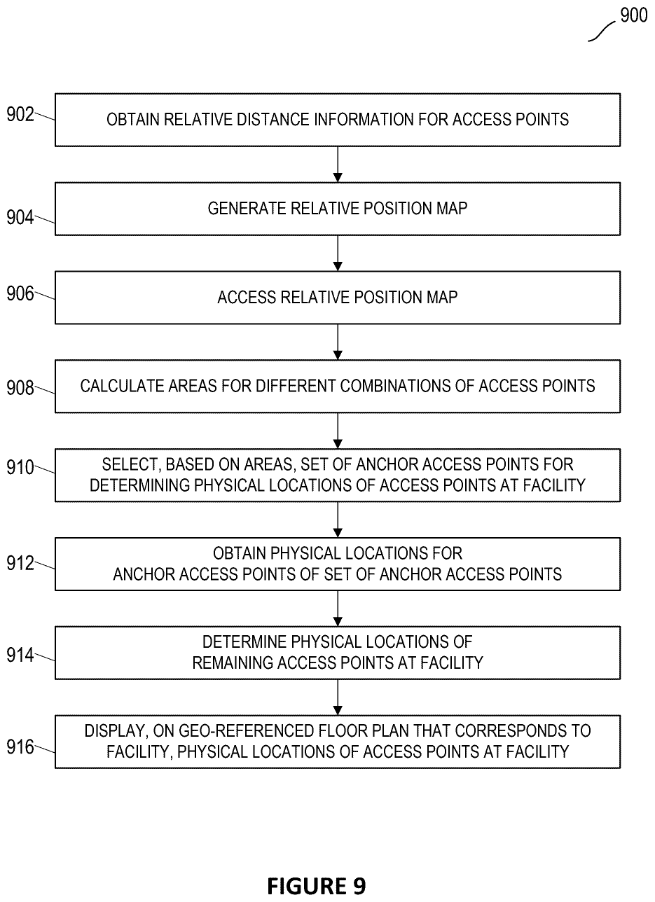

In certain implementations, it may be possible to automatically select anchor access points without performing a process of identifying APs 108 that are located on an outer boundary of a relative position map 218. To that end, a process for automatically selecting anchor access points may be provided that omits performing a process of identifying APs 108 that are located on an outer boundary of a relative position map 218. An example of such a process is described below with reference to FIG. 9.

Auto-locate computer system 104 may re-determine the physical locations of APs 108 at one or more times. For example, the physical location of one or more APs 108 may change, such as by a user physically moving the place of installation of the AP 108 within the facility of managed communication network 102. As another example, one or more new APs 108 may be installed at the facility of managed communication network 102 and added to managed communication network 102. As another example, one or more existing APs 108 may be removed from the facility of managed communication network 102 and deleted from managed communication network 102. These and potentially other events may change the contents of APs 108, and potentially may change the relative position map 218 such that updating the physical locations of APs 108 by auto-locate logic 210 may be appropriate. As part of this recalculation, anchor AP selection logic 226 may be re-executed to determine suitable anchor access points in view of the change(s) to managed communication network 102, though the selected anchor access points might or might not change. The re-execution of auto-locate logic 210 may be performed at one or more regular or irregular intervals, in response to a request (e.g., from a network manager), or at any other suitable time.

Auto-locate computer system 104 may be implemented using any suitable combination of hardware, firmware, and software. Some or all of the components of auto-locate computer system 104 may include programming for execution by processor 200, the programming including instructions to perform some or all of the functionality of auto-locate computer system 104. As just two examples, auto-locate logic 210 and anchor AP selection logic 226 (along with any other components of auto-locate computer system 104) may include programming for execution by processor 200, the programming including instructions to perform some or all of the functionality of auto-locate computer system 104, including executing the automatic selection of anchor access points and associated automatic location of the physical locations of APs 108.

At least a portion of memory 202 may be considered a computer-readable medium on which computer code (e.g., instructions, such as may be associated with auto-locate logic 210 and anchor AP selection logic 226) is stored. References to computer-readable medium, computer-readable storage medium, computer program product, tangibly embodied computer program, or the like, or a controller, circuitry, computer, processor, or the like should be understood to encompass not only computers having different architectures such as single or multi-processor architectures and sequential (Von Neumann) or parallel architectures but also specialized circuits such as FPGAs, ASICs, signal processing devices, and other devices. References to computer program, instructions, logic, code, or the like, should be understood to encompass software for a programmable processor or firmware such as, for example, the programmable content of a hardware device whether instructions for a processor, or configuration settings for a fixed-function device, gate array or programmable logic device, or the like.

While FIG. 2 illustrates a particular configuration of components, this disclosure contemplates other suitable configurations. For example, although FIG. 2 shows certain components as being part of the same device, any of the components may be grouped in sets of one or more components which may exist and execute as part of any number of separate and operatively connected devices. As another example, a single component may be configured to perform all or any portion of the functionality performed by the components shown in FIG. 2. Accordingly, implementations disclosed herein should not be limited to the configuration of components shown in FIG. 2.

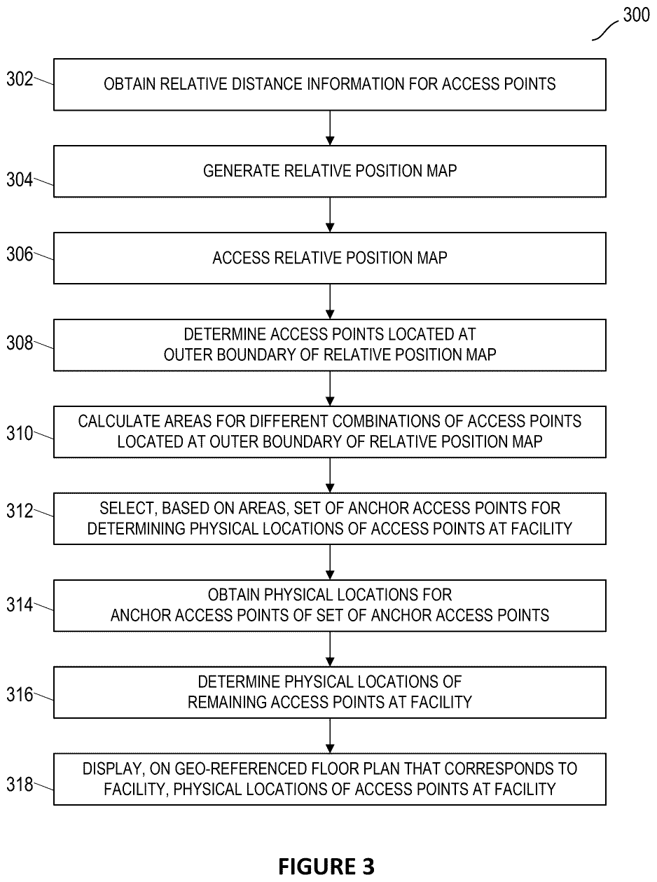

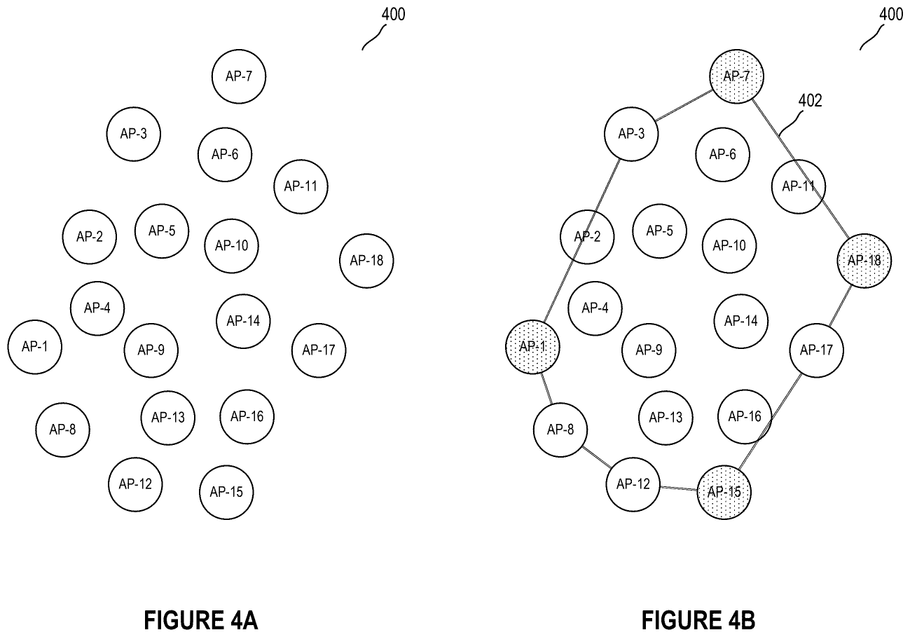

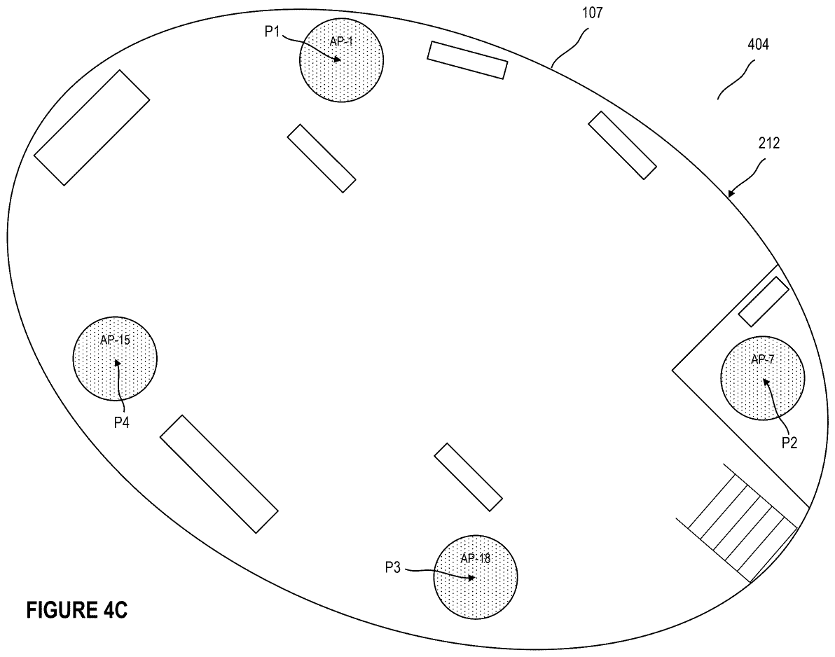

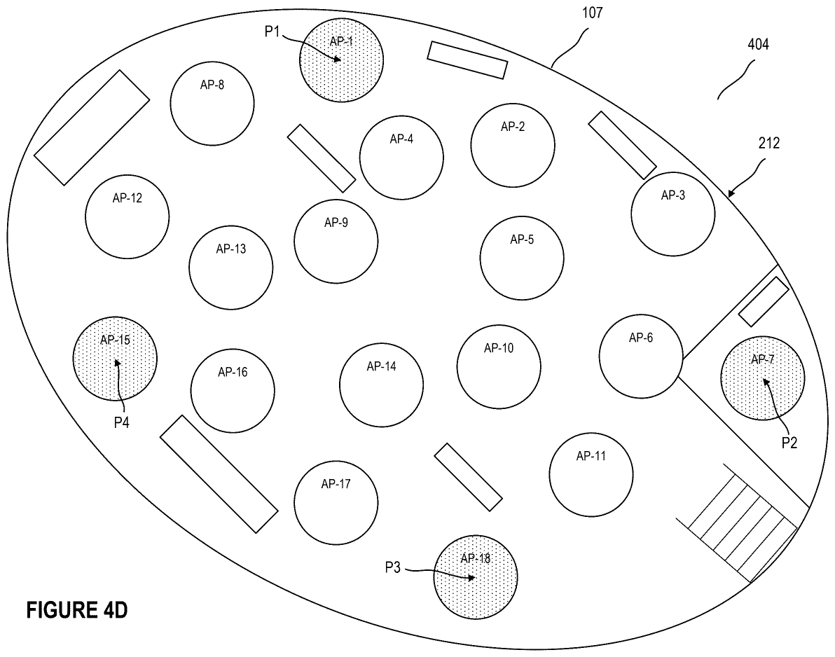

FIG. 3 and FIGS. 4A-4D will be described in connection with one another. FIG. 3 illustrates an example method 300 for automatically selecting anchor access points, according to certain implementations. FIGS. 4A-4D illustrate example visualizations to facilitate describing method 300 of FIG. 3, according to certain implementations. Additional details regarding what is shown in each of FIGS. 4A-4D are described below when the disclosure introduces those figures.

Turning to method 300, method 300 will be described using aspects of system 100 of FIG. 1 and auto-locate computer system 104 of FIG. 2 as examples, so reference may be made to items shown in those figures. In certain implementations, some or all operations of method 300 are performed by auto-locate computer system (e.g., by auto-locate logic 210 and/or anchor AP selection logic 226 of FIG. 2). For purposes of method 300, it will be assumed that a number of APs 108 have been deployed (e.g., installed) throughout a facility 107 and have been operational to form managed communication network 102. In certain implementations, APs 108 of managed communication network 102 may be installed or deployed by a client in their physical environment (e.g., facility 107), such as a physical floor, office building, warehouse, campus, or other facility, to provide wireless (e.g., Wi-Fi) coverage at the physical environment.

In certain implementations, the anchor AP selection process may be initiated using, for example, the auto-locate feature (e.g., such as by activating an interactive button, or using an input such as a mouse input, or a keyboard input). The auto-locate feature can be activated by a user by various means, such as by interacting with the user interface 118 (described previously in FIGS. 1A-1B) by for example, clicking an interactive button, or using other input methods like a mouse click or keyboard command. The auto-locate feature may attempt to simplify and streamline the process of determining locations of APs 108, a part of which may include automatically selecting anchor access points that may be optimal for determine the physical locations of APs 108.

At step 302, auto-locate computer system 104 may obtain AP distance information 216 between actual APs 108 of managed communication network 102 located at facility 107. AP distance information 216 may include distance measurements between pairs of APs 108, potentially captured by APs 108 themselves. APs 108 may, for example, determine the distances using AP signaling, such as using measurement of time of flight of signals between pairs of APs 108 to determine the distance between each pair of APs 108. For example, a distance determination may be made between an AP 108 and each other AP 108, and between every other pair of APs 108, to the extent possible.

In certain implementations, the distance measurements of distance information 216 may be obtained through FTM scans performed by APs 108 in managed communication network 102. FTM is a Wi-Fi technology that allows for precise distance measurements between devices (e.g., APs 108) using time of flight of frame exchange between a sending station and a receive station. Each AP 108 in managed communication network 102 may perform FTM scans to measure the distance of the AP 108 from other APs 108, creating a web of inter-AP distances across facility 107. In certain implementations, the FTM scans may be performed at regular or irregular intervals as a background task to provide ongoing, up-to-date distance information without disrupting normal network operations. In certain implementations, the FTM scans may be performed when the auto-locate feature is initiated (e.g., as described previously).

At step 304, auto-locate computer system 104 may generate a relative position map 218 based on AP distance information 216 obtained at step 302. Relative position map 218 may represent relative positions between APs 108 in a first coordinate system that is independent of the physical locations of the APs 108. The first coordinate system may be arbitrary relative to actual physical coordinates or locations of APs 108 at facility 107. In certain implementations, relative position map 218 may be a data structure, such as a table, a matrix (e.g., proximity matrix), or another suitable type of data structure. Auto-locate computer system 104 may store relative position map 218, such as in memory 202. Particular examples of relative position map 218 are illustrated in and described below with reference to FIGS. 5A-5B.

In certain implementations, in addition to generating a proximity matrix or other suitable data structure that stores the distances between APs 108, auto-locate computer system 104 may generate relative position map 218 to include locations of APs 108 within an arbitrary coordinate system. The proximity matrix data might not in itself describe the physical locations of APs 108 represented in the matrix. In certain implementations, auto-locate computer system 104 may analyze the proximity matrix to determine a respective location of each AP 108 in relation to each of the other APs 108. In certain implementations, auto-locate computer system 104 may use the determined locations in generating a map of APs 108, which may be part of relative position map 218.

In certain implementations, auto-locate computer system 104 may use a Multi-Dimensional Scaling (MDS) algorithm to determine relative coordinates in an arbitrary coordinate space for APs 108 using the distances (e.g., using the proximity matrix). For example, auto-locate computer system 104 may use an MDS algorithm to generate a set of locations representing the relative positions of APs 108 based on a table of the distances between APs 108. The set of locations may be in any number of dimensions, and, in terms of mapping APs 108 to locations in facility 107, may provide both 2D and 3D mapping based on a proximity table describing the distances between each pair of APs 108. Stated mathematically, MDS may be applied to translate information about pairwise distances among a set of n objects into a configuration of n points mapped into Cartesian space.

In certain implementations, processing the proximity matrix (or other suitable data structure for the distances between APs 108) may provide a set of locations of APs 108. While the set of locations of APs 108 provides the relationship of the locations of APs 108, the locations may be scaled differently than the physical locations of APs 108 and/or may be rotated, inverted, or otherwise misaligned in 2D or 3D space. That is, the set of locations may be oriented in any direction, or may be inverted, while satisfying the AP distance values. In certain implementations, auto-locate computer system 104 may resolve the scaling, rotation, and/or inversion of the set of locations using one or more actual known locations of APs 108, the so-called anchor access points.

The MDS algorithm may use the proximity matrix as an input, and transform these distances into a set of points in the Cartesian coordinate system, representing the relative positions of all APs 108. At this stage, the positions of the APs 108 are in an arbitrary coordinate system, and not yet aligned with the actual geo-referenced floor plan 212.

This set of AP locations (e.g., represented by the term POSᵢₙᵢₜᵢₐₗ) for the APs 108 may be expressed using the following equation (1):

$$P O {S}_{initial} = MDS ( PM ) \to \{ {P}_{1} ( {x}_{1} , {y}_{1} ) , {P}_{2} ( {x}_{2} , {y}_{2} ) , … , {P}_{n} ( {x}_{n} , {y}_{n} ) \} \qquad ( 1 )$$

where P₁(x₁,y₁) is the position of a first AP 108 of APs 108, where x₁ and y₁ are the x and y coordinates of the first AP 108, respectively, P₂(x₂,y₂) is the position of a second AP 108 of APs 108, where x₂ and y₂ are the x and y coordinates of the second AP 108, respectively, and Pₙ(xₙ, yₙ) represents the position of the nth AP 108 of APs 108, where xₙ and yₙ are the x and y coordinates of the nth AP 108, respectively, where n is the total number of APs 108 in managed communication network 102.

Although this disclosure describes auto-locate computer system 104 generating relative position map 218, this disclosure contemplates any suitable component generating relative position map 218. As just one example, computer system 110 at facility 107 (see FIG. 1) may might collect distance information from APs 108 and generate relative position map 218.

FIG. 4A illustrates an example AP relative position visualization 400 of example relative position map 218, according to certain implementations. In the illustrated example, AP relative position visualization 400 includes icons representing AP-1 through AP-18, which may be examples of APs 108. AP relative position visualization 400 shows the relative positions of APs 108 according to the distances indicated by AP distance information 216, though at a smaller scale. The orientation of the shape formed by the APs of AP relative position visualization 400 may be random and have no assumed correspondence to the orientation of a shape formed by APs 108 at facility 107.

As described above, the APs 108 selected as anchor access points may serve as reference points for determining physical locations of other APs 108 of managed communication network 102 at facility 107. These reference positions may be selected to be easily identifiable points within the environment, such as corners of the geo-referenced floor plan 250. In general, it may be desirable to select as anchor access points that are along the outer boundary of a shape formed by the physical locations of APs 108 and that are as far apart from one another as possible relative to other combinations of APs 108 that are on the outer boundary. Additionally, a target quantity of APs may be set, which may reflect a target quantity of anchor access points. In some scenarios, the target quantity of APs is three or more. For example, the target quantity of APs may be three, four, or another suitable value greater than three. In a particular example, the target quantity of APs is four.

As can be seen from AP relative position visualization 400, which reflects relative position map 218, even visually observing AP relative position visualization 400, it may be difficult to manually determine which APs 108 would qualify as “corner” APs 104 or would otherwise provide an optimal choice for being anchor APs. Auto-locate computer system 104 (e.g., anchor AP selection logic 226) may use relative position map 218 to automatically select anchor access points, such as for use with the auto-locate feature.

Returning to FIG. 3, at step 306, auto-locate computer system 104 may access relative position map 218. For example, auto-locate computer system 104 (e.g., anchor AP selection logic 226) may retrieve relative position map 218 from memory 202. As another example, auto-locate computer system 104 (e.g., anchor AP selection logic 226) may receive relative position map 218 from computer system 110.

At step 306, auto-locate computer system (e.g., anchor AP selection logic 226) may determine, from APs 108 (which may be considered a first plurality of APs 108), a subset of APs 108 (which may be considered a second plurality of APs 108 that is a subset of the first plurality of APs 108) located at an outer boundary of relative position map 218. In other words, auto-locate computer system 104 may process relative position map 218 to identify a subset of APs 108 located at an outer boundary of relative position map 218. The subset of APs 108 located at the outer boundary represents potential candidates to be anchor access points. In certain implementations, auto-locate computer system 104 applies a convex hull algorithm to relative position map 218 to identify the subset of APs 108 located at the outer boundary of relative position map 218. Although use of a convex hull algorithm is primarily described, this disclosure contemplates using any suitable technique for determining a subset of APs 108 that are located at an outer boundary of relative position map 218.

In certain implementations, a convex hull algorithm identifies APs 108 located at an outer boundary of relative position map 218. The convex hull algorithm may determine a subset of APs 108 that, when connected, form a convex polygon enclosing the other APs 108 of relative position map 218. A convex polygon is characterized by all interior angles being less than or equal to 180 degrees, with no vertices pointing inward. The convex hull algorithm may evaluate the coordinates of APs 108 in relative position map 218 to identify those APs 108 that would form vertices of such a convex polygon. APs 108 that would create a concave angle or lie within the polygon boundary may be excluded from the subset. The resulting subset of APs 108 identified by the convex hull algorithm represents candidate APs that lie along the outer boundary of the network deployment.

As just one particular example implementation, the convex hull algorithm processes a set of points P (e.g., APs 108) in a plane using coordinate geometry. The algorithm may implement Graham's scan, which sorts points by polar angle relative to a baseline point (typically the point with lowest y-coordinate), then iteratively evaluates triplets of consecutive points p1, p2, p3 to determine if they make a counter-clockwise turn. A counter-clockwise turn is determined by calculating the cross product: (p2.x−p1.x) (p3.y−p1.y)−(p2.y−p1.y) (p3.x−p1.x). If the cross product is positive, the three points make a counter-clockwise turn and p2 remains in the hull. If the cross product is negative, p2 is discarded as it would create a concave angle. The algorithm continues until all points have been processed, resulting in the subset of points forming the convex hull. It should be understood that this particular example implementation of a convex hull algorithm is provided for example purposes only.

In certain implementations, the convex hull algorithm may be extended to three dimensions to identify APs 108 located on an outer surface of a three-dimensional relative position map. This implementation may be particularly useful for multi-story facilities 107 or facilities 107 where APs are deployed across different elevations or floors. The three-dimensional convex hull algorithm may determine a subset of APs 108 that, when connected, form a convex polyhedron enclosing the other APs 108 in the three-dimensional space. Similar to the two-dimensional case, the algorithm may evaluate the coordinates (x, y, z) of the APs to identify those that would form vertices of the convex polyhedron. The algorithm may implement techniques such as Quickhull, which initializes with a simplex (tetrahedron) and iteratively adds points that maximize distance from the current hull faces. The resulting subset represents candidate APs 108 distributed across the outer surface of the three-dimensional network deployment.

Turning to FIG. 4B, using the AP relative position visualization 400 of FIG. 4A, FIG. 4B provides a visual representation of the outer boundary 402 that may be determined by auto-locate computer system 104 (e.g., anchor AP selection logic 226) at step 308. Outer boundary 402 links a subset of the APs (a subset of AP-1 through AP-18) and forms a convex polygon with the subset of APs as the vertices of the polygon. In particular, outer boundary 402 links the following APs in order (with an arbitrary starting and stopping point): AP-1, AP-3, AP-7, AP-18, AP-17, AP-15, AP-12, and AP-8. These APs of outer boundary 402 provide the subset of APs determined by auto-locate computer system 104 (e.g., anchor AP selection logic 226) at step 308. As can be seen, the outer boundary 402 provides a convex shape, and if any of the APs that form the vertices of outer boundary 402 are replaced with another AP, outer boundary 402 no longer would be convex. For example, AP-2 and AP-11 would be excluded from the subset because including them would result in a non-convex polygon.

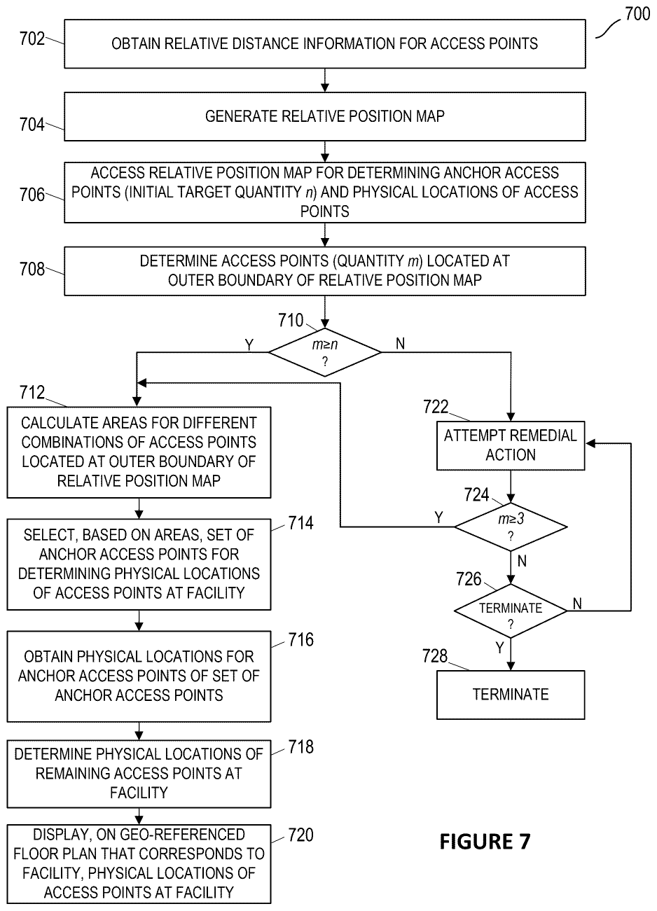

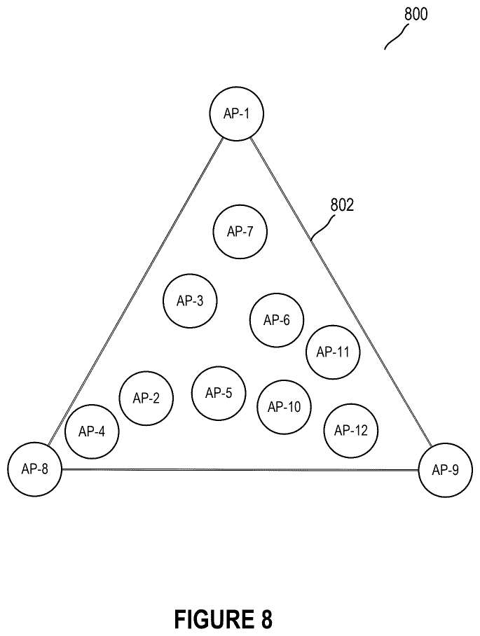

Returning to FIG. 3, in some scenarios, it is possible that auto-locate computer system 104 (e.g., anchor AP selection logic 226) identifies fewer APs 108 located at the outer boundary of relative position map 218 than the target quantity of APs 108. For example, it may be possible that the convex hull algorithm returns fewer APs 108 located at the outer boundary of relative position map 218 than the target quantity of APs 108, which may reflect a target quantity of anchor access points. Particular example techniques for handling this scenario are described in greater detail below with reference to FIGS. 7 and 8.

At step 310, auto-locate computer system 104 (e.g., anchor AP selection logic 226) may calculate areas for different combinations of APs 108 of the subset of APs 108 determined at step 308 (e.g., the second plurality of APs 108). Each combination of the different combinations of APs 108 may include the target quantity of APs 108. For example, if the target quantity of APs 108 is four, then each combination of APs 108 for which an area is determined at step 310 may include four APs 108 from the subset of APs 108 determined at step 308. For purposes of this disclosure, it will be understood that area could refer to area in two dimensions or area in three dimensions (volume), depending on implementation.

As an example, step 310 may include calculating areas [A1, A2, . . . . Ar], where m=boundary APs and r equals a total number of possible combinations according to a set of parameters, as described below. In other words, m may be the quantity of APs 108 in the subset identified at step 308. The target quantity of APs, which may reflect a target quantity of anchor access points, may be defined as n. The total number of possible combinations that include n APs from the m APs (r) may be defined according to the following equation (2):

$$r = m ! / ( n ! ( m - n ) ! ) \qquad ( 2 )$$

Returning to FIG. 4B, auto-locate computer system 104 (e.g., anchor AP selection logic 226) may calculate areas for each combination of four APs from the subset of APs determined at step 308 (AP-1, AP-3, AP-7, AP-18, AP-17, AP-15, AP-12, and AP-8. For purposes of this example, assume n=4 and, as shown above m=8. Thus, according to the above formula, the total number of possible combinations that include n APs from the m APs (r) is 70: A1=Area (AP-1,AP-3,AP-18,AP-15); A2=Area (AP-1,AP-7,AP-18,AP-15), . . . . A70.

Returning to FIG. 3, at step 312, auto-locate computer system 104 (e.g., anchor AP selection logic 226) may select, based on the areas calculated at step 310, a set of anchor access points for determining physical locations of the APs 108. In certain implementations, auto-locate computer system 104 (e.g., anchor AP selection logic 226) selects the combination of APs 108 having the maximum calculated area among the different combinations as the set of anchor access points. The determined set of anchor access points may include the target quantity of APs. The physical locations that are to be determined may correspond to a second coordinate system, which may be a coordinate system associated with a floor plan 212 for the facility 107 and may be geo referenced to the physical structure of facility 107.

Returning to FIG. 4B, auto-locate computer system 104 (e.g., anchor AP selection logic 226) may determine the maximum area from areas A1, A2, . . . . A70; that is, the area having the greatest value. Auto-locate computer system 104 (e.g., anchor AP selection logic 226) then may determine the combination of four APs (four being the target quantity of APs 108 in this example) that resulted in that maximum area and select that combination of APs 108 as the set of anchor access points. For purposes of this example, it will be assumed that APs AP-1, AP-7, AP-18, and AP-15 resulted in the greatest area and are determined to be the set of anchor access points. It should be understood that this selection is made for ease of explanation and might not necessarily be correct when drawn to scale or when using real-world distance measurements and associated calculations. AP-1, AP-7, AP-18, and AP-15 are shown as shaded in FIG. 4B to indicate their selection as anchor access points.

Returning to FIG. 3, at step 314, auto-locate computer system 104 may obtain physical locations of the anchor access points selected at step 312. The physical locations (e.g., anchor AP locations 222) may correspond to a coordinate system that differs from the coordinate system of relative position map 218. For example, the physical locations may correspond to a coordinate system associated with a floor plan 212 for the facility 107 and may be geo referenced to the physical structure of facility 107.

In certain implementations, to obtain the physical locations of the selected anchor access points, auto-locate computer system 104 may indicate to a user the selected anchor access points, such as by notifying the user of AP IDs 214 of the selected anchor access points. For example, auto-locate computer system 104 may provide anchor AP IDs 220 to prompt entry of the physical locations of the APs 108 selected by anchor AP selection logic 226 to be anchor access points.

Auto-locate module 210 may receive user-provided coordinates for the selected anchor APs on a geo-referenced floor plan (e.g., floor plan 212 shown in FIG. 2) of facility 107. The geo-referenced floor plan 212 may be input to auto-locate computer system 104 by a user (e.g., via user interface 206 of FIG. 2 and/or computer system 110 of FIG. 1) prior to or during the step 314. For example, the user may input the geo-referenced floor plan 212 during the auto-locate process and/or the anchor access point selection process, or the user may input the geo-referenced floor plan 212 before the auto-locate process and/or the anchor access point selection process is initiated. For example, auto-locate computer system 104 may prompt a user to manually input the locations of the selected anchor access points on the geo-referenced floor plan 212 via user interface 206.

FIG. 4C illustrates an example visualization 404 of a floor plan 212 for a facility 107 at which managed communication network 102 is installed. Visualization 404 may be displayed, such as via user interface 206 of FIG. 2 and/or computer system 110 of FIG. 1. As described above with reference to step 312 and FIG. 4B, in this example it will be assumed that anchor AP selection logic 226 selects AP-1, AP-7, AP-18, and AP-15 as anchor points for managed communication network 102/facility 107. The positions of the anchor access points AP-1, AP-7, AP-18, and AP-15 may be manually input into the visualization 404 of geo-referenced floor plan 212 by the user (e.g., by using an input device such as a keyboard input or a mouse input). For example, as shown in FIG. 4C, the user may manually place the anchor AP-1 at point P₁, the anchor AP-7 at point P2, the anchor AP-18 at point P3, and the anchor AP-15 at point P4 on visualization 404 of geo-referenced floor plan 212. As was the case in FIG. 4B, AP-1, AP-7, AP-18, and AP-15 include shading in FIG. 4C to indicate their selection as anchor access points.

The positions of the anchor access points (AP-1, AP-7, AP-18, and AP-15) (e.g., represented by the term UserAnchorPos) may be expressed using the following equation (3):

$$UserAnchorPos = \{ {P}_{a} ( {x}_{a} , {y}_{a} ) , {P}_{b} ( {x}_{b} , {y}_{b} ) , {P}_{c} ( {x}_{c} , {y}_{c} ) , {P}_{d} ( {x}_{d} , {y}_{d} ) \} \qquad ( 3 )$$

where Pₐ(xₐ,yₐ) represents the position of the anchor AP-1 at the point P₁, where xₐ and yₐ are its x and y coordinates respectively on the geo-referenced floor plan 212, P_{b}(x_{b}, y_{b}) represents the position of the anchor AP-7 at the point P2, where x_{b} and y_{b} are its x and y coordinates respectively on the geo-referenced floor plan 212, P_{c}(x_{c},y_{c}) represents the position of the anchor AP-18 at the point P3, where x_{c} and y_{c} are its x and y coordinates respectively on the geo-referenced floor plan 212, and P_{d}(x_{d},y_{d}) represents the position of the anchor AP-15 at the point P4, where xₐ and yₐ are its x and y coordinates respectively on the geo-referenced floor plan 212.

Returning to FIG. 3, at step 316, auto-locate computer system 104 (e.g., auto-locate logic 210) may determine physical locations of remaining APs 108 based on relative position map 218 and the physical location information for the set of anchor access points (e.g., anchor AP locations 222) as obtained at step 314. This disclosure contemplates auto-locate computer system 104 (e.g., auto-locate logic 210) using any suitable technique to determine physical locations of remaining APs 108 based on relative position map 218 and the physical location information for the set of anchor access points (e.g., anchor AP locations 222) as obtained at step 314.

In certain implementations, auto-locate computer system 104 may compute a transformation that maps the initial set of AP locations (from the step 304) to the geo-referenced floor plan 212 coordinates. The transformation may include translation, rotation, and/or scaling to align the initial set of AP locations to the geo-referenced floor plan 212. Auto-locate computer system 104 may apply the computed transformation to the initial set of AP locations to obtain a final set of AP locations.

Turning to FIG. 4D, FIG. 4D illustrates updated visualization 404 of floor plan 212 of facility 107, which now includes not only the APs 108 previously selected as anchor access points (AP-1, AP-7, AP-18, and AP-15) at their respective physical locations, but also the remaining APs 108 at their respective physical locations as determined at step 316. In the illustrated example, visualization 404 of floor plan 212 shows facility 107 to have an ovular shape. While the distribution and shape of APs 108 may be more important to selecting APs 108 to serve as anchor access points, certain building shapes, which may lack clear corners, may further illustrate the difficulty of leaving the selection of anchor access points to a user. In contrast certain implementations of this disclosure, however, automatically select APs 108 to serve as anchor access points in a manner that more likely leads to optimum selection of the anchor access points, and potentially to more accurate physical location determinations of the remaining APs 108.

Returning to FIG. 3, at step 318, auto-locate computer system 104 (e.g., auto-locate logic 210) may display, on updated visualization 404 of geo-referenced floor plan 212, physical locations of APs 108 at facility 107. Of course, in some scenarios, the visualization 404 of geo-referenced floor plan 212 may be displayed throughout some or all of the steps of method 300 (though possibly without indications of anchor access points positions (e.g., P1, P2, P3, P4) or APs 108, depending on the stage of method 300) such that a user can view and interact with the display during method 300.

In certain implementations, anchor AP selection logic 226 accounts for situations where physical verification of the location of an AP 108 selected by anchor access point selection logic 226 to be an anchor access point is difficult or otherwise not possible. For example, an AP 108 may be temporarily inaccessible due to construction work, being located in a restricted area, being mounted in a hard-to-reach location, or otherwise being difficult to physically locate within the facility. In such a scenario, when prompted to indicate the physical location of an AP 108 selected to be an anchor access point, a user may indicate that the location is unavailable or otherwise unable to be provided.

Continuing with this example, when auto-locate computer system 104 receives an indication that the location of an AP 108 selected to be an anchor access point cannot be physically verified, anchor AP selection logic 226 may identify an alternative AP 108 to be an anchor access point, such as from the previously calculated combinations. In certain implementations, anchor AP selection logic 226 may select the alternative anchor access point from a combination having the next-largest calculated area among the different combinations. For example, if an original selection included (from FIG. 4B) AP-1, AP-7, AP-18, and AP-15, but the location of AP-7 is unable to be verified, anchor AP selection logic 226 may suggest using AP-3 instead of AP-7 based on the combination AP-1, AP-3, AP-18, and AP-15 having the next-largest calculated area. This dynamic selection process may allow the system to proceed with location determination even when optimal anchor access points are unavailable, while still maintaining accuracy by selecting alternatives that maximize the geometric distribution of the anchor access points.

FIGS. 5A-5B illustrate examples of relative position map 218, according to certain implementations. In particular, FIG. 5A illustrates an example in which relative position map 218 is stored in a proximity table 500, and FIG. 5B illustrates an example in which relative position map is stored in a proximity matrix 502. FIGS. 5A and 5B illustrate just two example data structures for storing relative position map 218. This disclosure contemplates any suitable data structure being used to store relative position map.

Turning to FIG. 5A, table 500 may be a data structure that represents the relative distances between pairs (and possibly all pairs) of APs 108 of managed communication network 102. As illustrated in FIG. 5A, table 500 includes columns and rows. For purposes of the example of FIG. 5A, it will be assumed that managed communication network 102 includes ten APs 108, AP1 through AP10. Each of the ten APs 108 is represented in a corresponding row and in a corresponding column, with the cell at an intersection between a column and row including the distance (0, D1, D2, and so on) between the APs for the column and row that intersect at that cell. For example, the distance between AP4 and AP7 is indicated as D27 in table 500. The intersecting cell for a column and row that correspond to the same AP 108 includes a value of zero, representing the distance of an AP 108 to itself. In the illustrated example, proximity table 500 includes a column indicating the location of APs 108 within an arbitrary coordinate system. The abbreviation “AC” in AC1, AC2, and so on represents “arbitrary coordinates.” The location indicated in table 500 may be an example of the initial locations for APs 108 described above with reference to step 304 of method 300 of FIG. 3. For example, these initial locations may be determined using an MDS algorithm applied to the known distances between APs 108. Auto-locate computer system 104 may use table 500 as an input for calculations in the automatic anchor AP selection process.

Turning to FIG. 5B, proximity matrix 502 may be a data structure that represents the relative distances between pairs (and possibly all pairs) of APs 108 of managed communication network 102. As illustrated in FIG. 5B, proximity matrix 502 is an n×n square matrix, where n is the total number of APs 108 of managed communication network 102, and both rows and columns represent those APs 108. Each cell (i, j) in proximity matrix 502 contains the measured distance between AP i and AP j. The diagonal elements of proximity matrix 502 (where i=j) typically are zero, representing the distance of an AP 108 to itself. Auto-locate computer system 104 may use proximity matrix 502 as an input for calculations in the automatic anchor AP selection process.

FIG. 6 illustrates example AP location data structure 600, according to certain implementations. In the illustrated example, data structure 600 is shown to be a table, though data structure 600 may have any suitable format. Data structure 600 may store the physical locations of APs 108 of managed communication network 102, as determined by auto-locate computer system 104. For example, data structure 600 illustrates an example format for AP locations 224 of FIG. 2.

In the illustrated example, data structure 600 includes columns and rows. For purposes of the example of FIG. 6, it will be assumed that managed communication network 102 includes ten APs 108, AP1 through AP10. A first column includes the AP IDs for each of the APs 108, with each of the ten APs 108 being represented in a corresponding row of that column containing an APID for the AP 108. A second column includes the physical location for the AP 108, as determined by auto-locate computer system 104. In the illustrated example, the cells correspond to the AP ID and physical location for AP2, AP5, AP7, and AP9 are shaded to indicate that those APs 108 were determined by anchor AP selection logic 226 to be anchor access points. Additionally, a user may have provided the physical locations of those APs, as described above. The physical location for an AP 108 may be with respect to a coordinate system associate with a floor plan 212 for facility 107 housing managed communication network 102 and geo-referenced to physical locations of facility 107. The abbreviation “PC” in PC1, PC2, and so on represents “physical coordinates.” Auto-locate computer system 104 may output data structure 600 and/or use data structure 600 to generate a visualization of the locations of APs 108, such as a visualization of floor plan 212 with icons for APs 108 shown at the determined physical locations for those APs 108.

FIG. 7 illustrates an example method 700 for automatically selecting anchor access points, according to certain implementations. As described above, in some scenarios, it is possible that auto-locate computer system 104 (e.g., anchor AP selection logic 226) identifies fewer APs 108 located at the outer boundary of relative position map 218 than the target of anchor APs, which may reflect a target quantity of anchor access points. For example, it may be possible that the convex hull algorithm returns fewer APs 108 located at the outer boundary of relative position map 218 than the target quantity of APs. Method 700 includes example processing for addressing this scenario. It should be understood that method 700 can be combined with other implementations described throughout this disclosure.

Method 700 will be described using aspects of system 100 of FIG. 1 and auto-locate computer system 104 of FIG. 2 as examples, so reference may be made to items shown in those figures. In certain implementations, some or all operations of method 700 are performed by auto-locate computer system (e.g., by auto-locate logic 210 and/or anchor AP selection logic 226 of FIG. 2). For purposes of method 700, it will be assumed that a number of APs 108 have been deployed (e.g., installed) throughout a facility 107 and have been operational to form managed communication network 102. In certain implementations, APs 108 of managed communication network 102 may be installed or deployed by a client in their physical environment (e.g., facility 107), such as a physical floor, office building, warehouse, campus, or other facility, to provide wireless (e.g., Wi-Fi) coverage at the physical environment. The anchor AP selection process may be initiated in any suitable manner, including those examples described above.

Steps 702, 704, 706, and 708 of method 700 of FIG. 7 may generally correspond to steps 302, 304, 306, and 308, respectively, of method 300 of FIG. 3. The descriptions of steps 302, 304, 306, and 308 of method 300 of FIG. 3 are incorporated by reference into the description of FIG. 7 and, for the sake of conciseness, are not repeated.

For purposes of this example, it will be assumed that an initial target quantity of APs is n, and that the quantity of APs determined to be at the outer boundary of relative position map 218 is m. At step 710, auto-locate computer system 104 (e.g., anchor AP selection logic 226) may determine whether m≥n. In other words, auto-locate computer system 104 (e.g., anchor AP selection logic 226) may determine whether the quantity of APs determined to be at the outer boundary of relative position map 218 is greater than or equal to an initial target quantity of APs.

If auto-locate computer system 104 (e.g., anchor AP selection logic 226) determines at step 710 that m≥n, then method 700 may proceed to step 712. Steps 712, 714, 716, 718, and 720 of method 700 of FIG. 7 may generally correspond to steps 310, 312, 314, 316, and 318, respectively, of method 300 of FIG. 3. The descriptions of steps 310, 312, 314, 316, and 318 of method 300 of FIG. 3 are incorporated by reference into the description of FIG. 7 and, for the sake of conciseness, are not repeated. If, on the other hand, auto-locate computer system 104 (e.g., anchor AP selection logic 226) determines at step 710 that m<n, then method 700 may proceed to step 722, described below following the description of FIG. 8.

FIG. 8 illustrates an example scenario in which less than a target quantity of APs is determined to be at an outer boundary of relative position map 218, according to certain implementations. In other words, FIG. 8 illustrates an example scenario in which auto-locate computer system 104 (e.g., anchor AP selection logic 226) determines at step 710 that m<n.

In particular, FIG. 4B provides an AP relative position visualization 800 that includes a visual representation of the outer boundary 802 that may be determined by auto-locate computer system 104 (e.g., anchor AP selection logic 226) at step 708, where the number of APs 108 that form vertices of outer boundary 802 (m) is less than a target quantity of APs (n), which in this particular example will be assumed to be four. In this example, the outer boundary 802 includes three vertices (m=3), such that a polygon formed by connecting the vertices of outer boundary 802 form a triangle that includes vertices that correspond to the following APs: AP-1, AP-9, and AP-8.

Returning to FIG. 7, at step 722, in response to determining that m<n, auto-locate computer system 104 (e.g., anchor AP selection logic 226) may attempt a remedial action. The remedial action could be handled in a variety of ways, examples of which are described below.

In a first example, auto-locate computer system 104 (e.g., anchor AP selection logic 226) may attempt to proceed with the determine number of APs 108 determined to be at the outer boundary of relative position map 218 even though that number is less than the target quantity of APs. In other words, auto-locate computer system 104 (e.g., anchor AP selection logic 226) may reduce the target quantity of APs to have a modified value (e.g., n−1). Thus, in the example of FIG. 8, auto-locate computer system 104 (e.g., anchor AP selection logic 226) may attempt to proceed with the three APs 108 determined to be at the outer boundary of relative position map 218. In such an example, auto-locate computer system 104 (e.g., anchor AP selection logic 226) may determine at step 724 whether the quantity of APs 108 determined to be at the outer boundary of relative position map 218 is greater than or equal to a minimum quantity of APs (e.g., three). If so, then method 700 may proceed to step 712 using the APs 108 determined to be at the outer boundary of relative position map 218 even though the quantity of APs 108 determined to be at the outer boundary of relative position map 218 is less than the target quantity of APs, essentially resetting the target quantity of APs to three for this iteration. If auto-locate computer system 104 (e.g., anchor AP selection logic 226) determine at step 724 that the quantity of APs 108 determined to be at the outer boundary of relative position map 218 is less than the minimum quantity of APs (e.g., three), then method 700 may proceed to step 726, described below.

Returning to step 722, in another example, auto-locate computer system 104 (e.g., anchor AP selection logic 226) may attempt to determine a new (revised) outer boundary of APs 108 of relative position map 218 by discarding an AP 108 that was part of the original determine outer boundary (e.g., outer boundary 802 of FIG. 8) and determining a new outer boundary to determine whether the new outer boundary includes a quantity of APs 108 that is greater than or equal to the target quantity of APs. In such an example, auto-locate computer system 104 (e.g., anchor AP selection logic 226) may discard an AP 108 of the subset of APs 108 determined to form the outer boundary of relative position map 218 to determine, from all remaining APs 108 of relative position map 218, a new subset of APs 108 that form a new outer boundary of relative position map 218. Auto-locate computer system 104 (e.g., anchor AP selection logic 226) may repeat this process until a subset of APs 108 form an outer boundary that include at least the target quantity of APs. In response to identifying an outer boundary 802 that includes at least the target quantity of APs 108, auto-locate computer system 104 (e.g., anchor AP selection logic 226) may proceed to step 712 to calculate areas for different combinations of the APs of the new subset of APs using the initial value of n (the initial target quantity of APs) such that the areas for the different combinations are areas of polygons of n sides, with n being the initial value of n, and may select, based on the areas, a set of anchor access points for determining physical locations of the APs 108. In certain implementations, auto-locate computer system 104 (e.g., anchor AP selection logic 226) may run multiple iterations of this remedial process to discard each AP 108 of the initial subset of APs 108 to identify a combination that results in the largest area.

Returning to step 722, in another example, auto-locate computer system 104 (e.g., anchor AP selection logic 226) may attempt to automatically select anchor access points without again performing a process of identifying APs 108 that are located on an outer boundary of a relative position map 218. In this example, auto-locate computer system 104 may proceed with a process similar to the process described below with reference to FIG. 9, essentially attempting to identify the combination of n APs 108 of relative position map 218 that form an n-sided polygon of a greatest area from all possible n-membered combinations of all APs 108 of relative position map 218. In this example, the determination at step 724 would result in a “yes,” such that method 700 would proceed to step 712 with the identified combination of APs 108.

At step 726, auto-locate computer system 104 (e.g., anchor AP selection logic 226) may determine whether to terminate, which may include determining whether to terminate the automatic selection of anchor access points portion of the auto-locate process or determining whether to terminate the auto-locate process entirely. This determination could be based on any suitable factors, according to particular needs.

If auto-locate computer system 104 (e.g., anchor AP selection logic 226) determines at step 726 not to terminate, then method 700 may return to step 722 to again attempt a remedial action, which could include again discarding an AP 108 to attempt to determine an acceptable quantity of APs 108 of relative position map 218 to serve as anchor access points. If, on the other hand, auto-locate computer system 104 (e.g., anchor AP selection logic 226) determines at step 726 to terminate, then method 700 may proceed to step 728 to terminate method 700, which may include notifying the user that the user is free to pick any APs 108 as anchor access points (potentially with some informative guidance) or notifying the user that the auto-locate feature failed in its entirety.

FIG. 9 illustrates an example method 900 for automatically selecting anchor access points, according to certain implementations. In certain implementations, it may be possible to automatically select anchor access points without performing a process of identifying APs 108 that are located on an outer boundary of a relative position map 218. To that end, method 900 provides an example of a process for automatically selection anchor access points that omits performing a process of identifying APs 108 that are located on an outer boundary of a relative position map 218.

Method 900 will be described using aspects of system 100 of FIG. 1 and auto-locate computer system 104 of FIG. 2 as examples, so reference may be made to items shown in those figures. In certain implementations, some or all operations of method 900 are performed by auto-locate computer system (e.g., by auto-locate logic 210 and/or anchor AP selection logic 226 of FIG. 2). For purposes of method 900, it will be assumed that a number of APs 108 have been deployed (e.g., installed) throughout a facility 107 and have been operational to form managed communication network 102. In certain implementations, APs 108 of managed communication network 102 may be installed or deployed by a client in their physical environment (e.g., facility 107), such as a physical floor, office building, warehouse, campus, or other facility, to provide wireless (e.g., Wi-Fi) coverage at the physical environment. The anchor AP selection process may be initiated in any suitable manner, including those examples described above.

Steps 902, 904, and 906 of method 900 of FIG. 9 may generally correspond to steps 302, 304, and 306, respectively, of method 300 of FIG. 3. The descriptions of steps 302, 304, and 306 of method 300 of FIG. 3 are incorporated by reference into the description of FIG. 9 and, for the sake of conciseness, are not repeated.

At step 908, auto-locate computer system 104 (e.g., anchor AP selection logic 226) may calculate areas for different combinations of APs 108, which may include all APs 108 of managed communication network 102 rather than just a subset of APs 108 at an outer boundary of relative position map 218 (e.g., the second plurality of APs 108) as described above with reference to steps 308 and 310 of method 300 of FIG. 3. Continuing with method 900, each combination of the different combinations of APs 108 may include the target quantity of APs 108. For example, if the target quantity of APs 108 is four, then each combination of APs 108 for which an area is determined at step 908 may include four APs 108. For purposes of this disclosure, it will be understood that area could refer to area in two dimensions or area in three dimensions (volume), depending on implementation.

As an example, step 908 may include calculating areas [A1, A2, . . . . Ar], where t=a total quantity of APs and r equals a total number of possible combinations according to a set of parameters, as described below. In other words, t may be the quantity of APs 108 in managed communication network 102. The target quantity of APs, which may reflect a target quantity of anchor access points, may be defined as n. The total number of possible combinations that include n APs from the t APs (r) may be defined according to the following equation (4):

$$r = t ! / ( n ! ( t - n ) ! ) \qquad ( 4 )$$

Auto-locate computer system 104 (e.g., anchor AP selection logic 226) may calculate areas for each combination of four APs from all 18 APs 108 of managed communication network 102. For purposes of this example, assume n=4 and, as shown above t=18. Thus, according to the above formula, the total number of possible combinations that include n APs from the t APs (r) is 3,060.

Returning to FIG. 9, steps 910, 912, 914, and 916 of method 900 may generally correspond to steps 312,314, 316, and 318, respectively, of method 300 of FIG. 3. The descriptions of steps 312, 314, 316, and 318 of method 300 of FIG. 3 are incorporated by reference into the description of FIG. 9 and, for the sake of conciseness, are not repeated.

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer system, comprising:
one or more processors; and
one or more non-transitory computer-readable storage media storing programming for execution by the one or more processors, the programming comprising instructions to:
access a relative position map of a first plurality of access points of a wireless network, the relative position map determined according to distance measurements between pairs of access points of the first plurality of access points and corresponding to a first coordinate system;
determine, from the first plurality of access points, a second plurality of access points located at an outer boundary of the relative position map, the second plurality of access points being a subset of the first plurality of access points;
calculate areas for different combinations of the access points of the second plurality of access points, each combination of the different combinations comprising a target quantity of access points of the second plurality of access points; and
select, based on the areas, a set of anchor access points for determining physical locations of the first plurality of access points, the physical locations corresponding to a second coordinate system, the first coordinate system being independent of the physical locations of the first plurality of access points, the set of anchor access points having the target quantity of access points.

2. The computer system of claim 1, wherein the instructions to determine, from the first plurality of access points, a second plurality of access points located at an outer boundary of the relative position map comprise instructions to process the relative position map according to a convex hull algorithm to identify the second plurality of access points located at the outer boundary of the relative position map.

3. The computer system of claim 1, wherein the instructions to select, based on the areas, the set of anchor access points comprise instructions to select a combination of access points having a maximum calculated area among the different combinations.

4. The computer system of claim 1, wherein:
a quantity of the second plurality of access points is m; and
the target quantity of access points is n, where an initial value of n is represented as n≥3.

5. The computer system of claim 4, wherein the initial value of n is represented as n=4.

6. The computer system of claim 4, wherein the programming comprises instructions to:
determine whether m≥n;
in response to determining that m≥n:
calculate the areas for the different combinations of the access points of the second plurality of access points using the initial value of n such that the areas for the different combinations are areas of polygons of n sides, n being the initial value of n; and
select, based on the areas, the set of anchor access points for determining the physical locations of the access points in the wireless network, where the set is n anchor access points, n being the initial value of n; and
in response to determining that m<n, attempt a remedial action.

7. The computer system of claim 6, wherein:
the initial value of n is represented as n≥4;
the instructions to attempt the remedial action comprise instructions to:
reduce the target quantity of access points to n−1 such that a modified value of n is represented as n−1;
calculate the areas for the different combinations of the access points of the second plurality of access points using the modified value of n such that the areas for the different combinations are areas of polygons of n−1 sides, n−1 being the modified value of n; and
select, based on the areas, the set of anchor access points determining the physical locations of the access points in the wireless network, where the set is n−1 anchor access points, n−1 being the modified value of n.

8. The computer system of claim 1, wherein the programming further comprises instructions to provide an alternative to at least one of the anchor access points in the set of anchor access points.

9. The computer system of claim 1, wherein the programming further comprises instructions to:
obtain physical location information for the set of anchor access points; and
determine physical locations of remaining access points of the first plurality of access points based on the relative position map and the physical location information for the set of anchor access points.

10. A computer system, comprising:
one or more processors; and
one or more non-transitory computer-readable storage media storing programming for execution by the one or more processors, the programming comprising instructions to:
access a relative position map of a first plurality of access points of a wireless network, the relative position map determined according to distance measurements between pairs of access points of the first plurality of access points, wherein a target quantity of access points is n, where an initial value of n is represented as n≥4;
determine, from the first plurality of access points, a second plurality of access points located at an outer boundary of the relative position map, the second plurality of access points being a subset of the first plurality of access points, a quantity of the second plurality of access points being m;
determine whether m≥n;
in response to determining that m≥n:
calculate areas for different combinations of the access points of the second plurality of access points using the initial value of n such that the areas for the different combinations are areas of polygons of n sides, n being the initial value of n; and
select, based on the areas, a set of anchor access points for determining physical locations of the first plurality of access points, where the set is n anchor access points, n being the initial value of n; and
in response to determining that m<n, attempt a remedial action.

11. The computer system of claim 10, wherein the initial value of n is represented as n=4.

12. The computer system of claim 10, wherein:
the instructions to attempt the remedial action comprise instructions to:
reduce the target quantity of access points to n−1 such that a modified value of n is represented as n−1;
calculate the areas for the different combinations of the access points of the second plurality of access points using the modified value of n such that the areas for the different combinations are areas of polygons of n−1 sides, n−1 being the modified value of n; and
select, based on the areas, the set of anchor access points determining the physical locations of the access points in the wireless network, where the set is n−1 anchor points, n−1 being the modified value of n.

13. The computer system of claim 10, wherein the instructions to attempt the remedial action comprise instructions to:
for each access point in the first plurality of access points that is not part of the second plurality of access points:
use the access point as an n^{th} access point of the second plurality of access points to form a candidate third plurality of access points such that the candidate third plurality of access points has n access points;
determine an area of a polygon formed by the candidate third plurality of access points, the polygon having n sides; and
select, based on the areas, the set of anchor access points determining the physical locations of the access points in the wireless network, where the set is n anchor access points, n being the initial value of n.

14. The computer system of claim 10, wherein the instructions to attempt the remedial action comprise instructions to:
discard an access point of the second plurality of access points to form a third plurality of access points; and
determine, from the third plurality of access points, a fourth plurality of access points located at a revised outer boundary of the relative position map, the fourth plurality of access points being a subset of the third plurality of access points;
calculate areas for different combinations of the access points of the fourth plurality of access points using the initial value of n such that the areas for the different combinations are areas of polygons of n sides, n being the initial value of n; and
select, based on the areas, a set of anchor access points for determining physical locations of the first plurality of access points, where the set is n anchor access points, n being the initial value of n.

15. The computer system of claim 10, wherein the relative position map comprises coordinates in an arbitrary coordinate system unrelated to physical locations of the access points of the first plurality of access points.

16. The computer system of claim 10, wherein:
the instructions to determine, from the first plurality of access points, the second plurality of access points located at the outer boundary of the relative position map comprise instructions to process the relative position map according to a convex hull algorithm to identify the second plurality of access points located at the outer boundary of the relative position map; and
the instructions to select, based on the areas, the set of anchor access points comprise instructions to select a combination of access points having a maximum calculated area among the different combinations.

17. The computer system of claim 10, wherein the programming further comprises instructions to:
obtain physical location information for the set of anchor access points; and
determine physical locations of remaining access points of the first plurality of access points based on the relative position map and the physical location information for the set of anchor access points.

18. A computer-implemented method, comprising:
accessing, by a computer system, a relative position map of a plurality of access points of a wireless network, the relative position map determined according to distance measurements between pairs of access points of the plurality of access points and corresponding to a first coordinate system;
calculating, by the computer system, areas for different combinations of the access points of the plurality of access points, each combination of the different combinations comprising a target quantity of access points of the plurality of access points; and
selecting, by the computer system and based on the areas, a set of anchor access points for determining physical locations of the access points of the plurality of access points in the wireless network, the physical locations corresponding to a second coordinate system, the first coordinate system being independent of the physical locations of the access points of the plurality of access points, the set of anchor access points having the target quantity of access points.

19. The computer-implemented method of claim 18, wherein selecting, based on the areas, the set of anchor access points comprises selecting a combination of access points having a maximum calculated area among the different combinations.

20. The computer-implemented method of claim 18, further comprising:
obtaining, by the computer system, physical location information for the set of anchor access points; and
determining, by the computer system, physical locations of remaining access points of the plurality of access points based on the relative position map and the physical location information for the set of anchor access points.
